(19) United States
(12) Patent Application Publication
(10) Pub. No.: US 2002/0100195 A1
(43) Pub. Date: Aug. 1, 2002

(54) Water globe with special effects

(76) Inventor: Shun-Hsi Hsu, Tainan (TW)

Correspondence Address: KAM C. LOUIE, c/o LADAS & PARRY, Suite 2100, 5670 Wilshire Boulevard, Los Angeles, CA, 90036-5679, US

(21) Appl. No.: 09/771,442

(22) Filed: Jan. 26, 2001

(51) Int. Cl. G09F 19/00; G09F 19/08

(52) U.S. Cl. 40/409; 40/411

(57) ABSTRACT

A water globe arrangement includes a fluid pump immersed in a fluid within the fluid-containing glass dome, the fluid pump drawing fluid in through a fluid inlet and expelling the fluid through a fluid outlet, thereby circulating the fluid and creating a visual movement effect within the glass dome. In one aspect of the invention, a glass dome is filled with water and contains a number of small free particles having a specific gravity greater than that of the water. Upon activation of the fluid pump, a continuous flow of circulating fluid keeps the free particles in constant motion within the glass dome. In another embodiment of the invention, the fluid pump forces fluid within the glass dome along an elongated passageway coupled to the pump fluid outlet for directing the flow of fluid to a location remote from the fluid outlet. In such an arrangement, the fluid exiting the elongated passageway may be located above the level of the fluid within the glass dome and simulate the flow of lava from a volcano structure situated within the glass dome. Alternatively, the passageway may exit at or near the fluid level within the glass dome and simulate a bubbling brook, hot springs, or the like.

### BACKGROUND OF THE INVENTION

1. Field of the Invention

This invention relates to the creation of special effects within a water globe. More particularly, the invention produces interesting and unusual visual effects within a water globe.

2. Brief Description of the Prior Art

Conventional water globe arrangements comprise a base and a glass globe with internal structural designs surrounded by water. Typically, the interior of the glass globe also contains a number of small white free particles having a specific gravity less than that of the water in the globe. As a result, the small white particles settle to the bottom of the glass globe, and when the entire water globe is inverted or shaken, the small white particles randomly float or circulate through the water for a time, eventually settling again at the bottom of the glass globe. While the effect of falling snow is interesting and attractive, such water globes must be manually inverted or shaken repeatedly in order to maintain a continuous effect of falling snow or a snow storm. That is, the desired visual effect is short-lived, lasting only about 20-30 seconds until the water globe needs to be further agitated.

Prior art water globes may also house a rotational object within the glass globe dome. Typically, a motor beneath the glass dome is the driving mechanism for causing an object, visible through the glass dome, to rotate. However, being limited to a rotating shaft upon which objects may be placed within the glass dome, the variety of special effects are likewise limited. Moreover, the common object being subjected to movement within the glass dome is generally a solid figure such as a dancer, skater, tree, or other ornamental object.

Recognizing the limitations as noted above, there is a need in the art for a water globe which produces special effects on a continuous basis and/or causes interesting and unusual movement effects other than that of a rotating solid physical object.

### SUMMARY OF THE INVENTION

The present invention provides a water globe arrangement which satisfies all of the aforementioned needs for water globe special effect improvements.

In a preferred embodiment of the invention, there is provided a water globe arrangement comprising a water globe base supporting a fluid-containing glass dome in sealed relationship, a fluid pump immersed in a fluid within the fluid-containing glass dome, the fluid pump drawing fluid in through a fluid inlet and expelling the fluid through a fluid outlet, thereby circulating the fluid and creating a visual movement effect within the glass dome.

In one aspect of the invention, a glass dome is filled with water and contains a number of small free particles having a specific gravity greater than that of the water. Upon activation of the fluid pump, a continuous flow of circulating fluid keeps the free particles in constant motion within the glass dome.

In another embodiment of the invention, the fluid pump forces fluid within the glass dome along an elongated passageway coupled to the pump fluid outlet for directing the flow of fluid to a location remote from the fluid outlet of the pump. In such an arrangement, the point of exit for the fluid exiting the elongated passageway may be located anywhere within the glass dome. For example, in a glass dome only partially filled with fluid, it may be located above the level of the fluid and simulate the flow of lava from a simulated volcano structure situated within the glass dome. Alternatively, the passageway may exit at or near the fluid level within the glass dome and simulate a bubbling brook, hot springs, water fountain, or the like.

In yet a further alternate embodiment of the invention, the fluid exiting the passageway at a remote location from the pump outlet may be directed along a specific path toward an object placed within the glass dome, and a single free body may be forced along the predetermined path toward the object in a structured or rather random fashion. For example, the exit from the passageway may be at one side of the glass dome, the free body may be a simulated soccer ball, and the object located diametrically opposite the exit end of the passageway may be a soccer net, whereby the soccer ball is accelerated along the predetermined path due to the vortex action of the fluid exiting the passageway and tending to form a cavity or vacuum to draw the soccer ball into the movement of fluid along the passageway and into the net (having a rear exit to permit continuous operation).

A variety of combinations of a free body, or bodies, and an object at opposite ends of the path, from the passageway exit to the object, can be implemented in accordance with any design criteria desired. For example, instead of a soccer ball and net combination, a simulated baseball and a batter, a bowling ball and a set of bowling pins, or a football and a goal post, may be substituted, these being examples only of a limitless number of free body and object combinations. In the description to follow, the simulation of lava flowing from the top of a simulated volcano object within the glass dome will be used as exemplary.

### BRIEF DESCRIPTION OF THE DRAWING

Further objects and advantages and a better understanding of the present invention may be had by reference to the following detailed description taken in conjunction with the accompanying drawings in which:

FIG. 1 is a perspective view of a water globe arrangement which produces a continuous snow flurry or storm effect;

FIG. 2 is a perspective view of an alternative water globe arrangement which simulates the continuous flowing of lava down the sloping sides of a volcano;

FIG. 3 is a cross-sectional view of the interface between the base of a water globe and the glass dome thereof, as well as the structure of the fluid pump within the glass dome;

FIG. 4 is a top plan view of a fluid pump of the preferred type employed in the present invention;

FIG. 5 is an enlarged view of a portion of FIG. 3 to better illustrate the flow of fluid through the pump mechanism;

FIG. 6 is a view similar to that of FIG. 5, but with the pump forcing fluid up through a tubular passageway to a location remote from the fluid pump outlet;

FIG. 7 is a plan view of a cover plate employed in one embodiment of the invention which provides local/direct flow of fluid from the fluid pump to the interior of the glass dome;

FIG. 8 is a bottom view of a diverter which is attached to the cover plate of FIG. 7 for directing the fluid in a particular direction;

FIG. 9 is a top plan view of the diverter shown in FIG. 8;

FIG. 10 is a plan view of a cover plate employed in the embodiment of the invention in which fluid is forced through a tubular passageway to a remote location;

FIG. 11 is a bottom view of a diverter, in the form of a tubular passageway support, which is attached to the cover plate of FIG. 10 for directing the fluid in a particular direction;

FIG. 12 is a top plan view of the diverter shown in FIG. 11;

FIG. 13 is a plan view of a four-pole magnet used in the coupling between the motor and fluid pump according to the present invention;

FIG. 14 is an exploded perspective view of a tubular passageway and its mechanical connection with the cover plate of FIG. 10 and the diverter support of FIG. 11; and

FIG. 15 is a partial cross sectional view of the water globe shown in FIG. 2 showing the electrical components and wiring for supplying electrical energy to the motor of the fluid pump and to a number of lamps which are provided to illuminate portions of the simulated lava flow from a volcano disposed within the glass dome of the water globe.

### DETAILED DESCRIPTION OF THE PREFERRED EMBODIMENTS

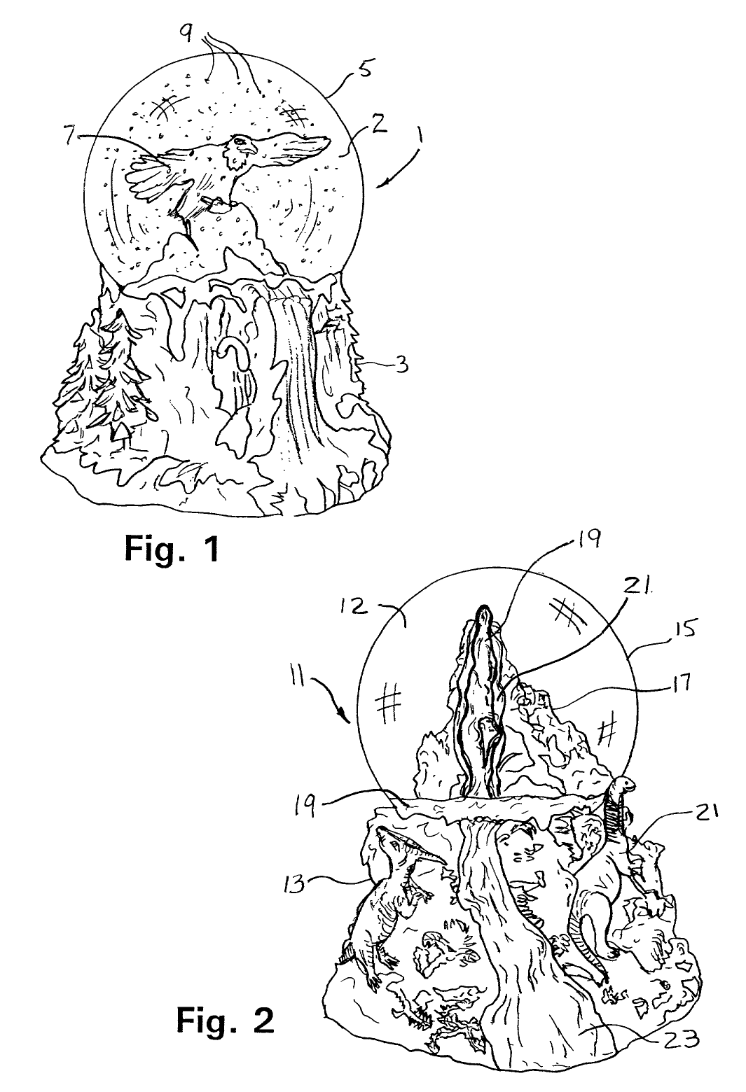

FIG. 1 is a perspective view of a water globe 1 having a base 3 and a glass dome 5, the glass dome 5 being filled with a fluid 2, e.g. water. An object 7 is fixed within the glass dome 5, in this example an eagle perched on a rock. A number of free particles 9 simulating snow flakes are contained within the glass dome 5 and have a specific gravity greater than that of the fluid 2. As a result, without any agitation of the fluid 2, the free particles 9 will settle to the bottom of the glass dome 5. However, as will be explained in detail hereinafter, the present invention provides continuous circulation of fluid 2 within the glass dome 5 to display a continuous snow flurry within the glass dome 5.

FIG. 2 is a perspective view of an alternate embodiment of the invention in which a water globe arrangement 11 comprises a base 13 and a glass dome 15. Within the glass dome 15, an object 17, in this example in the form of the top of a volcano, is centrally located within the glass dome 1S, and a shallow pool of fluid 19 is settled to the bottom of the glass dome 15 as shown. Base 13 may exhibit interesting theme-related features 20 to enhance the visual spectacle of the water globe arrangement.

While the base 13 and object 17 are solid formations, such as ceramic, each such object may be provided with a translucent simulated lava flow stream, the upper lava flow stream 21 being contained within the glass dome 15, and the bottom simulated lava flow stream 23 separates portions of the base 13 on either side, as will be explained hereinafter. The translucent simulated lava flow streams 21 and 23 extend to a hollow interior of the respective object 17 and base 13, and are accessible within such hollow interiors.

As will be explained, a number of lamps may be situated within the hollow interiors of the object 17 and base 13, and when illuminated, give the effect of red-hot or orange-hot lava, even though the translucent simulated lava flow streams 21 and 23 are of translucent plastic material and fixed in place. However, due to internal pumping action, the fluid 19, which also may be of a bright red or orange color, at the base of the volcano top 17 is forced upwardly along a passageway and exits from the top of the object 17 to form a continuous flow of fluid 19 down the side of the volcano preferably, but not necessarily, on top of the translucent simulated lava flow stream 21.

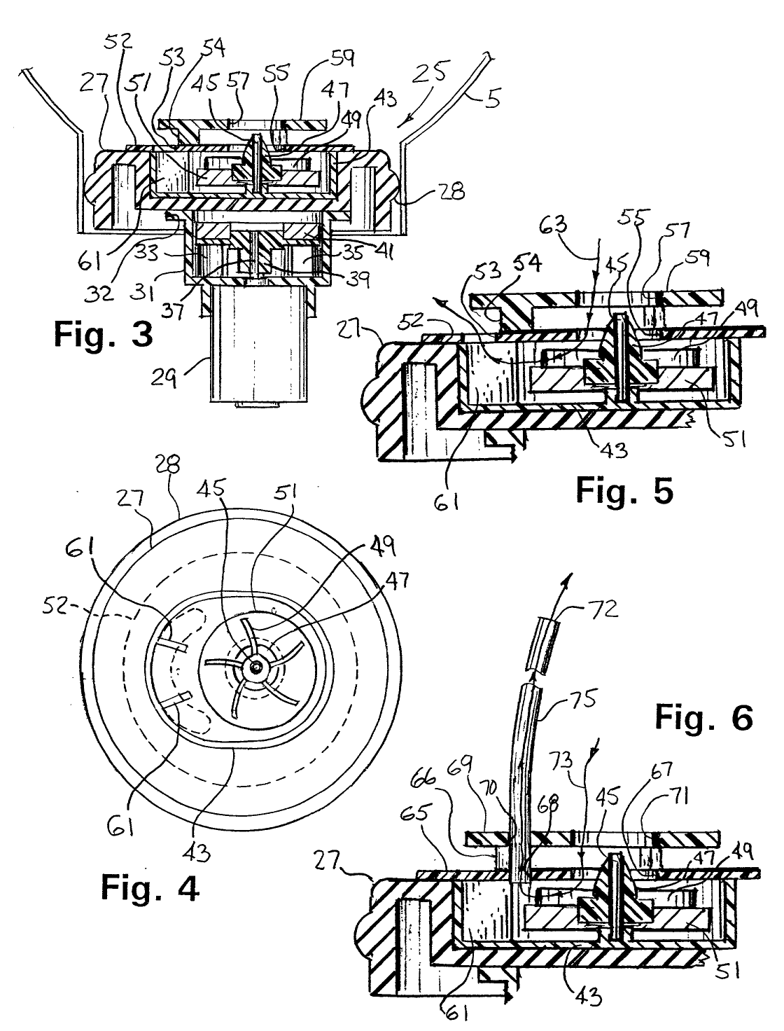

For the description of FIG. 3, reference is also made to FIGS. 4, 5, 7-9, and 13. As seen in FIG. 3, the glass dome 5 is sealed at its mouth at the bottom thereof by a rubber plug 27, as is known in the art. Other than for purposes of routing wires for a lamp in the glass dome 5, which can be permanently and securely sealed, there are no openings through the rubber plug 27 to cause any leakage of the water.

A fluid pump 25 is shown in FIG. 3 as two separate mechanisms, one above and one below the rubber plug 27.

Below the rubber plug 27 is a motor 29 fixed to a motor mount fitting 31 having a top flange 32 glued to the bottom of the rubber plug 27. The side walls 33 of the fitting 31 are provided with spaced windows 35 for the circulation of cooling air around the top of the motor 29.

The motor 29 has a shaft 37 about which is fixed a magnet support plate 39 which carries an annular four-pole magnet 41 (FIG. 13) which rotates upon rotation of the shaft 37 of motor 29.

The rotation of magnet 41 thus creates a rotating magnetic field which penetrates the rubber plug 27 to extend to the top portion of the fluid pump arrangement 25.

Within a formed cavity in rubber plug 27, there is fitted a pump fluid chamber 43 which fixedly mounts a vertical shaft 45 about which is a freely rotatable plastic hub 47 which has a plurality of substantially radially extending impeller blades 49. The hub 47 is glued to the top of the four-pole magnet 51. Therefore, with rotation of magnet 51, the impeller blades 49, rotating counterclockwise from above with reference to the plan view of FIG. 4, force fluid that arise at the center of the impeller blades 49 radially outwardly of the blades. Since the shaft 45 of the impeller blade and hub assembly 49, 47 is off-centered within the pump fluid chamber 43, a relatively high fluid pressure will be experienced at the left end of the pump fluid chamber 43.

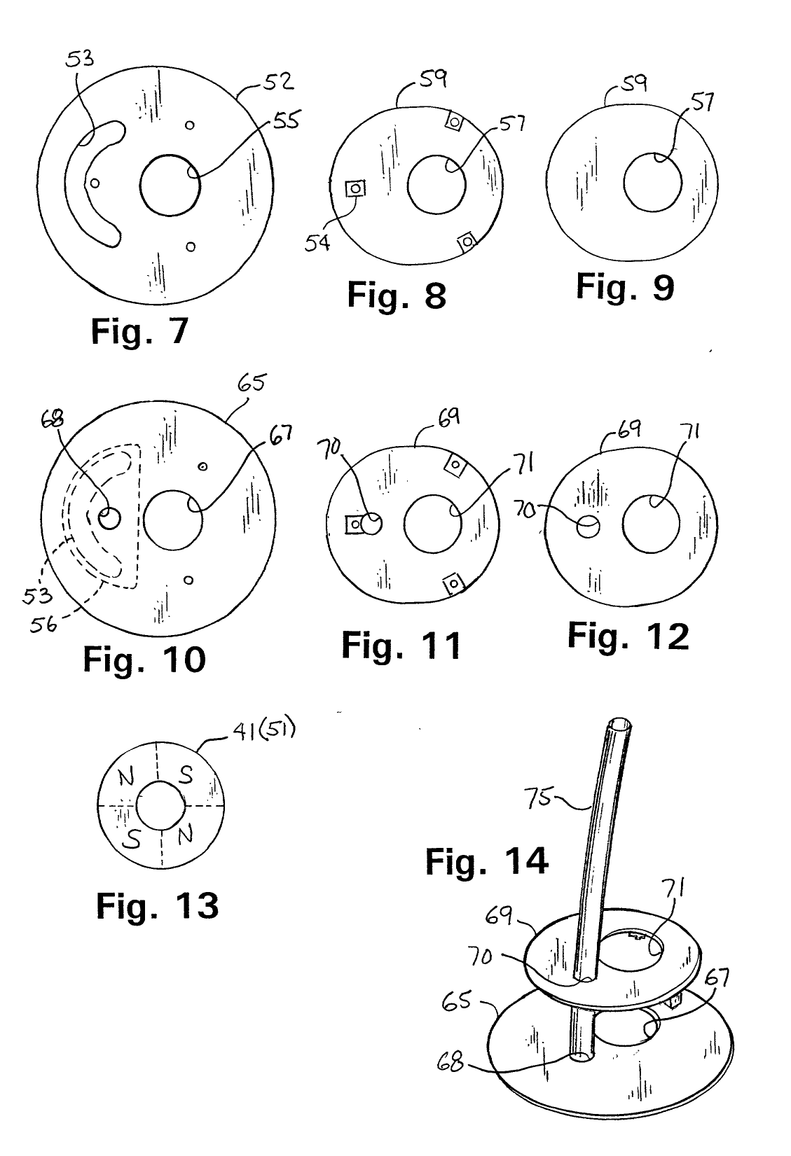

Turning now, in particular, to FIG. 5, which shows an enlarged partial view of the arrangement shown in FIG. 3, it will be noted that, with the placement of cover plate 52 (FIG. 7) glued to the top of rubber plug 27, fluid is drawn through opening 55 in cover plate 52, the opening 55 defining an inlet for the fluid pump 25. The passage of fluid through the pump 25 is along the multi-headed arrow 63 shown in FIG. 5. That is, fluid enters the inlet opening 55, is propelled to the left side of chamber 43, and exits an outlet 53 as best seen in FIG. 7.

To increase the pressure within the pump fluid chamber 43, at the left side thereof, a pair of bulkhead plates 61 extend radially inwardly from the left side of the pump fluid chamber 43, thus preventing circulation of the fluid peripherally about the center of impeller blades 49, and forcing the higher pressure fluid at the left side of chamber 43 upwardly (its only other available path) and out the crescent shaped outlet opening 53. This arrangement of elements comprising the fluid pump 25 will create the required fluid agitation within the glass dome 5 to cause continuous random movement of the free particles 9 (FIG. 1).

However, in order to create a more circuitous path for the free particles 9 within the glass dome 5, a diverter 59 (FIGS. 8 and 9) is fixed above cover plate 52 and spaced therefrom by a plurality of support legs 54. Thus, the fluid exiting outlet 53 in cover plate 52 will hit the overhang of diverter 59 and force the fluid into a more horizontal direction. By this means, the free particles will be disbursed more randomly, and the observer is less able to detect the presence of a pumping action causing the free particles to move within the glass dome 5, as it would be more noticeable if the fluid movement was vertical. So as not to restrict fluid being inputted to the fluid pump 25 through inlet opening 55, the diverter 59 is provided with an aligned diverter inlet 57 (FIGS. 8 and 9), thereby avoiding restricting the flow of fluid along the path 63 shown in FIG. 5.

FIG. 6 is a view similar to that of FIG. 5, but with a different arrangement for the passage of fluid out of the pump fluid chamber 43. The arrangement of FIG. 6 employs a cover plate 55 as shown in FIG. 10, differently configured than the cover plate 52 shown in FIG. 7. In FIG. 10, the cover plate 65 is shown to have an inlet 67 comparable to that of inlet 55 of cover plate 52, but in place of the crescent shaped outlet 53 on cover plate 52, cover plate 65 has a single small circular opening 68 within which is tightly forced the end of a plastic tubular passageway 75, as best seen in FIGS. 6 and 14.

The motor and magnet drive mechanism is the same as that described in connection with FIG. 3, and the pump fluid chamber and impeller blade assembly is also similar to that described in connection with the FIG. 3 embodiment. However, as can be seen by reference to FIG. 6, when the fluid pump is active, fluid is drawn down through the aligned inlet opening 71 of the tubular passageway support member 69, through the inlet opening 67 of cover plate 65, and is forced by the action of the impeller blades 49 up through the tubular passageway 75 to an exit end 72 remote from the outlet of the fluid pump. That is, the fluid acted upon by the impeller blades 49 is carried to a remote position, and is thus perfectly suited for carrying the fluid up to the top of the simulated volcano object 17 (FIG. 2). As seen in FIG. 2, the fluid exiting the tubular passageway (not shown in FIG. 2) will simulate a lava flow stream 19 from the top of object 17 down the side thereof as explained previously with respect to the description of FIG. 2.

The exploded view of the subassembly shown in FIG. 14 employs the construction of the tubular passageway support 69, the remote flow cover plate 65, and the tubular passageway 75 itself.

Although a specific example of forcing the pumped fluid to a remote location is shown herein in the form of a simulated volcano action, it will be understood that there is no limitation to the placement of the end of the tubular passageway, the configuration of the tubular passageway, or the direction of flow of fluid out of the tubular passageway 75 when other applications are contemplated. For example, a shorter tubular passageway 75 meant to expel the fluid horizontally and relatively low in the interior of glass dome 15 may be employed to implement the variations of the invention described supra, e.g., soccer ball and net combination.

The phantom lining shown in FIG. 10 indicates that, for efficiency in production and reduction of inventory parts, a common cover plate 52 can be simply modified to produce an equivalent cover plate 65 if, for example, a thin inexpensive D-shaped piece of plastic 56 can be glued to the upper surface of cover plate 52 to block passage of the fluid through outlet 53, and a hole 68 may be drilled into the modified cover plate 52 to accommodate the lower end of the tubular passageway 75.

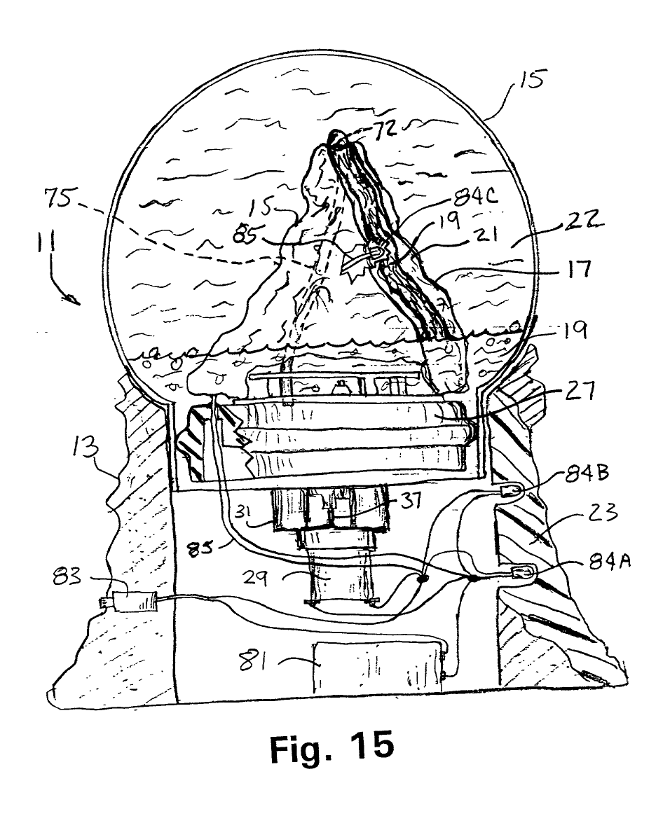

FIG. 15 is a partial cross sectional view of the water globe arrangement shown in FIG. 2, taken from a different angle. FIG. 15 specifically shows the electrical power source, switching, and lamp arrangement which can be used with any embodiment of the invention described or constructed within the scope of the present invention according to this specification.

In FIG. 15, a battery pack 81 supplies power to one side of each of the lamps 84A, 84B, and 84C which are embedded within the plastic translucent simulated lava flow streams 21 and 23. The same power lead from battery pack 81 is also routed to one side of the DC motor 29. The other terminal of the battery pack 81 is connected to one contact of switch 83 accessible by an operator on one side of the base. The other contact of the switch 83 then is connected to the other sides of lamps 84A-C and motor 29. Thus, when switch 83 is turned to the ON position, the lamps 84A-C illuminate the translucent simulated lava flow stream members 21 and 23 and simultaneously cause the motor 29 to activate and circulate the fluid 19 through the fluid pump 25 (FIGS. 3 and 6), up the tubular passageway 75 to exit at the end 72 of the tubular passageway 75 and flow down the side of the volcano upper portion 17 back to the reservoir of fluid 19.

To this point, the embodiment of FIGS. 2 and 15 have been described with respect to a fluid only partially filling the glass dome 15. However, in an alternative embodiment, a second fluid 22, being clear and of a specific gravity less than that of fluid 19, may fill the remainder of the glass dome 15 as seen in FIG. 15.

Several advantages are apparent using the two fluids 19, 22 rather than just a single fluid 19. One advantage is that the fluid 19 will flow slower down the side of the object 17 due to the immersion of the fluid 19 within another fluid environment. When a second fluid 22 is used, the pump pressure may also be increased without fear of splattering the fluid 19 exiting the top of the object 17. Finally, from an observer's viewpoint, the fact that there are two fluids in the same container and yet there is no homogeneous mixture of the two makes for a more interesting and provocative type of entertainment device.

While only certain embodiments have been set forth, alternative embodiments and various modifications will be apparent from the above description to those skilled in the art. These and other alternatives are considered equivalents and within the spirit and scope of the present invention.

What is claimed is:

1. A water globe arrangement comprising:
a water globe base supporting a fluid-containing glass dome in sealed relationship;
a fluid pump immersed in a fluid within said fluid-containing glass dome, said fluid pump drawing fluid in through a fluid inlet and expelling said fluid through a fluid outlet, thereby circulating said fluid and creating a visual movement effect within said glass dome.

2. The water globe arrangement as claimed in claim 1, comprising:
at least one free particle within said glass dome, said particle having a specific gravity greater than that of said fluid; and wherein
said circulating fluid is effective to cause movement of said particle in the direction of fluid flow, defining said visual movement effect.

3. The water globe arrangement as claimed in claim 1, comprising:
a plurality of free particles within said glass dome, each of said particles having a specific gravity greater than that of said fluid; and wherein
the movement of said plurality of particles simulates wind blown snow defining said visual movement effect.

4. The water globe arrangement as claimed in claim 3, wherein:
said fluid pump is adapted for continuously drawing fluid through said fluid inlet and continuously expelling fluid through said fluid outlet to simulate a continuous snow flurry.

5. The water globe arrangement as claimed in claim 1, wherein:
said fluid pump comprises a diverter to direct the flow of expelled fluid in a predetermined direction.

6. The water globe arrangement as claimed in claim 5, comprising:
at least one free particle within said glass dome, said particle having a specific gravity greater than that of said fluid; and wherein
said circulating fluid is effective to cause movement of said particle in the direction of fluid flow defining said visual movement effect; and
said free particle is repeatedly carried by said fluid flow along a predetermined path in said predetermined direction.

7. The water globe arrangement as claimed in claim 1, comprising:
an elongated passageway coupled to said pump fluid outlet for directing the flow of fluid to a location remote from said fluid outlet.

8. The water globe arrangement as claimed in claim 7, wherein:
said glass dome is partially filled with said fluid, and said passageway carries said fluid from said pump fluid outlet to a location above the level of fluid in said glass dome.

9. The water globe arrangement as claimed in claim 8, comprising:
a geological object disposed within said glass dome, said object having a top which is above the level of the fluid in said glass dome; and wherein
said passageway deposits said fluid on said object above the level of said fluid.

10. The water globe arrangement as claimed in claim 9, wherein:
said object is a simulated rock formation; and
said fluid flows over said rock formation to simulate a waterfall.

11. The water globe arrangement as claimed in claim 9, wherein:
said object is a simulated rock formation; and
said fluid flows over said rock formation to simulates an erupting volcano.

12. The water globe arrangement as claimed in claim 6, comprising:
an object disposed in said glass dome, and wherein:
said free particle is a simulated ball, and said simulated ball is projected along said predetermined path and in said predetermined direction to impinge said second object.

13. The water globe arrangement as claimed in claim 9, wherein:
said fluid only partially fills the interior of said glass globe;
a second fluid at least partially fills the remainder of the interior of the glass dome; and
said second fluid is lighter than said first-mentioned fluid and floats on top of said first-mentioned fluid.

14. The water globe arrangement as claimed in claim 11, wherein:
said fluid only partially fills the interior of said glass globe;
a second fluid at least partially fills the remainder of the interior of the glass dome;
said second fluid is lighter than said first-mentioned fluid and floats on top of said first-mentioned fluid; and
said first fluid is the color of molten lava, and said second fluid is clear and without color.

15. The water globe arrangement as claimed in claim 1, comprising:
an electrical power source;
an electrical switch;
at least one lamp; and
electrical wires interconnecting said power source, said switch, and said lamps, whereby operating said switch turns said lamps on and off, selectively, and wherein said lamps illuminate objects within said glass dome.

16. The water globe arrangement as claimed in claim 15, wherein:
said fluid pump comprises a pump motor; and
said electrical wires interconnect said power source, said switch, said lamps, and said motor, whereby operating said switch turns said lamps and said motor on and off.

17. The water globe arrangement as claimed in claim 15, wherein:
said lamps illuminate at least portions of said base.
